(19) United States
(12) Patent Application Publication
(10) Pub. No.: US 2021/0184254 A1
(43) Pub. Date: Jun. 17, 2021

(54) NANOSCALE INTERFACIAL COATING FOR STABILIZING ELECTROLYTE WITH HIGH-VOLTAGE CATHODE

(71) Applicant: The Trustees of Columbia University in the City of New York, New York, NY (US)

(72) Inventors: Yuan YANG, New York, NY (US); Tianyao GONG, Beijing (CN); Haowei ZHAI, Bronx, NY (US); Bingqing XU, New York, NY (US); Aijun LI, New York`, NY (US)

(73) Assignee: The Trustees of Columbia University in the City of New York, New York, NY (US)

(21) Appl. No.: 17/186,067

(22) Filed: Feb. 26, 2021

Related U.S. Application Data
(63) Continuation of application No. PCT/US2019/049318, filed on Sep. 3, 2019.
(60) Provisional application No. 62/725,914, filed on Aug. 31, 2018.
(60) Provisional application No. 62/819,224, filed on Mar. 15, 2019.
(60) Provisional application No. 62/892,226, filed on Aug. 27, 2019.
(60) Provisional application No. 62/893,945, filed on Aug. 30, 2019.
(60) Provisional application No. 62/893,981, filed on Aug. 30, 2019.

(51) Int. Cl. H01M 10/0562; H01M 4/505; H01M 4/525; H01M 10/0525; H01M 4/04

(52) U.S. Cl. CPC H01M 10/0562; H01M 4/505; H01M 2004/028; H01M 10/0525; H01M 4/0471; H01M 4/525

(57) ABSTRACT

A high-voltage cathode for use in a lithium-ion battery includes an LiCoO₂ (LCO) substrate and a ceramic electrolyte coating, e.g., Li_{1.5}Al_{0.5} Ge_{1.5} (PO₄)₃ (LAGP), disposed on the substrate. The coating includes one or more layers that are configured to stabilize an interface between the substrate and a polymer electrolyte. A decomposed salt layer is disposed over the ceramic electrolyte layer. The coating significantly enhances interfacial stability between the cathode and advantageous electrolytes such as poly(ethylene) oxide without sacrificing energy density. The coating also enables the practical use of high-voltage cathodes with lithium metal anodes and polymer electrolytes for higher energy density energy storage devices with reduced propensity for ignition.

### CROSS REFERENCE TO RELATED APPLICATIONS

This application is a continuation of International Patent Application No. PCT/US2019/049318, filed on Sep. 3, 2019, which claimed the benefit of U.S. Provisional Patent Application Nos. 62/725,914, filed on Aug. 31, 2018; 62/819,224, filed on Mar. 15, 2019; 62/892,226, filed Aug. 27, 2019; 62/893,945, filed Aug. 30, 2019; and 62/893,981, filed Aug. 30, 2019, which are all incorporated herein by reference in their entirety.

### BACKGROUND

Rechargeable lithium-ion batteries (LIBs) are widely used in various portable electronics since their first commercialization by Sony Corporation in 1991. Now LiCoO₂ (LCO) is used presently in >31% of LIBs that are manufactured. Specifically, the LCO has a high theoretical capacity of 274 mAh g⁻¹, but the practical discharge capacity is only ˜145 mAh g⁻¹ (Li₁₋ₓCoO₂, x˜0.5, ˜4.25 V vs. Li/Li+). When operating at voltages >4.25 V to get a higher capacity, the cycling efficiency and discharge capacity of LCO cells decay rapidly. And the electrolytes using in LIBs are flammable, which have potentially thermal runaway and catastrophic failures in large-scale deployment.

LIBs with higher energy density and greater power output are urgently needed. To realize high energy density, significant developments of cathode materials (e.g., high-voltage LiCoO₂ (LCO), Ni-enriched Li(NiCo_{y}Mn_{1-x-y})O₂(NCM) and LiNi_{1-x-y}CoₓAl_{y}O₂ (NCA)) with either high capacity or high voltage, as well as anodes with high capacity (e.g. lithium metal) should be used. Along with the pursuit of high energy density, safety is also critical component to avoid thermal runaway and catastrophic failures in large-scale deployment. To become viable, the cathode materials should be useable at higher voltages and the electrolytes for lithium batteries should have high flash point, which is difficult to ignite.

Solid electrolytes include both ceramic electrolytes and polymer electrolytes. Although ceramic electrolytes have high conductivities of 10⁻⁴-10⁻² S/cm, their usage is still impeded by the high interfacial impedance with electrode materials. Furthermore, it is also a great challenge to manufacture pure ceramic-based solid state batteries at large scale.

Polymer electrolytes, such as poly (ethylene oxide) (PEO), have gained widespread interest as promising candidates for rechargeable solid-state lithium batteries because of their low cost and compatibility with state-of-the-art manufacturing processes. PEO-based electrolytes are much safer than liquid electrolytes due to the high flash point. PEO electrolytes have been reported to be chemically compatible with lithium metal, which makes them more attractive than carbonate electrolytes used in Li-ion batteries. Electric vehicle “Bluecars” equipped with LiFePO₄ (LFP)/PEO/Li-metal battery have been commercialized by Bollore. However, they need to be operated at 70-80° C. and has a limited specific energy of 100 Wh kg⁻¹ at the system level. Further, the poor interfacial stability between the high voltage cathodes, such as LCO and NCM, limits their viability, and PEO electrolytes further impede their applications in 4 V lithium batteries with high energy density, which substantially deteriorates the cycling performance and significantly limits the energy density. Additionally, the unsatisfactory ionic conductivity, <10⁻⁴ S/cm at room temperature, hinders their practical applications in high-performance batteries.

### SUMMARY

Some embodiments of the present disclosure are directed to a cathode for use in a lithium-ion battery, including a substrate and a coating disposed on the substrate including one or more layers, the coating configured to stabilize an interface between the substrate and a polymer electrolyte. In some embodiments, the substrate includes LiCoO₂ (LCO), Li(NiₓCo_{y}Mn_{1-x-y})O₂ (NCM), LiNi_{1-x-y}CoₓAl_{y}O₂ (NCA), or combinations thereof. In some embodiments, the one or more layers includes a metal oxide. In some embodiments, the metal oxide is aluminum oxide. In some embodiments, the metal oxide layer has thickness between about 1 nm and about 3 nm. In some embodiments, the one or more layers includes a ceramic electrolyte. In some embodiments, the ceramic electrolyte includes Li_{1.5}Al_{0.5}Ge_{1.5}(PO₄)₃(LAGP), Li₁₊ₓAlₓTi₂₋ₓ(PO₄)₃ (LATP), or combinations thereof. In some embodiments, the cathode has a weight percent of ceramic electrolyte between about 0.5% and about 10%. In some embodiments, the cathode has a weight percent of ceramic electrolyte between about 1.5% to about 3.5%. In some embodiments, the one or more layers includes a decomposed salt layer.

Some embodiments of the present disclosure are directed to a lithium-ion battery, including a cathode including a substrate and a coating disposed on the substrate, an anode, and an electrolyte interfacing with both the cathode and the anode, wherein the coating includes one or more layers and is configured to stabilize an interface between the cathode and the electrolyte, wherein the one or more layers includes an oxide or a ceramic compound, and wherein the battery is configured for stabile operation at or above 4 V. In some embodiments, the electrolyte includes poly(ethylene oxide) (PEO), polyethylene glycol (PEG), a carbonate, or combinations thereof, and one or more salts including lithium bis(trifluoromethanesulfonyl)imide (LiTFSI), lithium bis(oxalato)borate (LiBOB), lithium hexafluorophosphate (LiPF₆), Li₇La₃Zr₂O₁₂ (LLZO), aluminum oxide, or combinations thereof. In some embodiments, the substrate includes LiCoO₂ (LCO), Li(NiₓCo_{y}Mn_{1-x-y})O₂ (NCM), LiNi_{1-x-y}CoₓAl_{y}O₂ (NCA), or combinations thereof, and the coating includes Li_{1.5}Al_{0.5}Ge_{1.5}(PO₄)₃ (LAGP), Li₁₊ₓAlₓTi₂₋ₓ(PO₄)₃ (LATP), aluminum oxide, or combinations thereof. In some embodiments, the anode includes lithium metal or graphite.

Some embodiments of the present disclosure are directed to a method of making a cathode for use in a lithium-ion battery, the method including grinding one or more substrate materials and one or more ceramic electrolytes, combining the one or more substrate materials and the one or more ceramic electrolytes with a solvent to form a composite, and sintering the composite. In some embodiments, grinding the one or more substrate materials and ceramic electrolytes includes a ball milling process. In some embodiments, sintering the composite includes drying the composite and sintering the dried composite above about 600° C. In some embodiments, the method includes forming in situ a decomposed salt layer over the composite.

### BRIEF DESCRIPTION OF THE DRAWINGS

FIG. 1 is a schematic representation of a high-voltage cathode according to some embodiments of the present disclosure;

FIG. 2 is a schematic representation of an energy storage device incorporating a high-voltage cathode according to some embodiments of the present disclosure;

FIG. 3 is a schematic representation of a surface coating of a high-voltage cathode according to some embodiments of the present disclosure;

FIG. 4A is a chart of a method of making a cathode according to some embodiments of the present disclosure;

FIG. 4B is a chart of a method of making a cathode according to some embodiments of the present disclosure;

FIG. 4C is an x-ray diffraction graph of bare LCO and LAGP-modified LCO particles according to some embodiments of the present disclosure;

FIG. 4D is a scanning electron microscopy image of LAGP-LCO particles according to some embodiments of the present disclosure;

FIG. 4E is a transmission electron microscopy image of an LAGP-LCO particle according to some embodiments of the present disclosure;

FIG. 5A is a graph showing cycling performance of LCO/Li and LAGP-LCO/Li cells in the voltage range of 3-4.25 V;

FIG. 5B is a graph showing voltage profiles of an LAGP-LCO/Li cell according to some embodiments of the present disclosure;

FIG. 5C is a graph showing voltage profiles of a bare LCO/Li cell;

FIG. 5D is a graph showing cycling performance of LCO/Li and LAGP-LCO/Li cells in the voltage range of 3-4.3 V;

FIG. 5E is a graph showing cycling performance of LCO/Li and LAGP-LCO/Li cells in the voltage range of 3-4.4 V;

FIG. 6A is a graph showing cycling performance of LAGP-LCO/Li cells between 3 and 4.25 V with 0.4 M LiBF₄ in PEO/PEGDME/EC/PC (PEO:PEGDME:EC/PC=3:3:4, by weight);

FIG. 6B is a graph showing cycling performance of LAGP-LCO/Li cells between 3 and 4.25 V with 0.4 M LiPF₆ in PEO/PEGDME/EC/PC (PEO:PEGDME:EC/PC=3:3:4, by weight);

FIG. 6C is a graph showing cycling performance of LAGP-LCO/Li cells between 3 and 4.25 V with 0.28 M LiTFSI+0.19 M LiBOB in PEO/PEGDME (PEO:PEGDME=1:1, by weight);

FIG. 6D is a graph showing cycling performance of LAGP-LCO/Li cells between 3 and 4.25 V with 1 M LiTFSI+1 M LiDFOB in PEO/PEGDME (PEO:PEGDME=1:1, by weight);

FIG. 7A is a graph showing cycling performance of bare LCO/Li and LAGP-LCO/Li cells with 0.46 M LiTFSI+0.3 M LiBOB+0.04 M LiPF6 in PEO/PEGDME/EC/PC (PEO:PEGDME:EC/PC=2:1:1, by weight) at 40° C.;

FIG. 7B is a graph showing cycling performance of LCO/Li and LAGP-LCO/Li cells at RT and 0.2 C in 2.7-4.3 V;

FIG. 7C is a graph showing cycling performance of bare LCO/Li and LAGP-LCO/Li cells with 0.46 M LiTFSI+0.3 M LiBOB+0.04 M LiPF6 in PEO/PEGDME/EC/PC (PEO:PEGDME:EC/PC=2:1:1, by weight) at 40° C.;

FIG. 7D is a graph showing cycling performance of LCO/Li and LAGP-LCO/Li cells with 40 μm Li at 0.3 C in 3.0-4.25 V;

FIG. 7E is a graph showing cycling performance of bare NCM523/Li and LAGP-NCM523/Li cells at 0.3 C in 3.0-4.3 V;

FIG. 7F is a graph showing cycling performance of LCO/Li and LAGP-LCO/Li cells at 0.5 C discharge in 3.0-4.25 V;

FIG. 8A is a graph showing cycling performance of bare LCO/Li and LAGP-LCO/Li cells with 1 M LiPF6 in EC/DEC (EC:DEC=1:1, w/w) in the voltage range of 3.0-4.5 V;

FIG. 8B is a graph showing voltage profiles of LCO/Li and LAGP-LCO/Li cells in the voltage range of 3-4.5 V;

FIG. 8C is a graph showing cycling performance of bare LCO/Li and LAGP-LCO/Li cells with 1.2 M LiPF6 in EC/EMC (EC:EMC=3:7, v/v) in the voltage range of 3.0-4.5 V;

FIG. 8D is a graph showing cycling performance of bare LCO/Li and LAGP-LCO/Li cells with 0.6 M LiTFSI+0.4 M LiBOB+0.05 M LiPF6 in EC/PC (EC:PC=3:7, v/v) in the voltage range of 3.0-4.5 V;

FIG. 8E is a graph showing capacity retention of LAGP-LCO/Li cells according to some embodiments of the present disclosure; and

FIG. 9 is a graph showing cycling performance of full-cells with bare LCO or 3.5% LAGP-LCO electrodes at room temperature in the voltage range of 3.0-4.45 V (vs. graphite) at a current density of 0.41 mA cm².

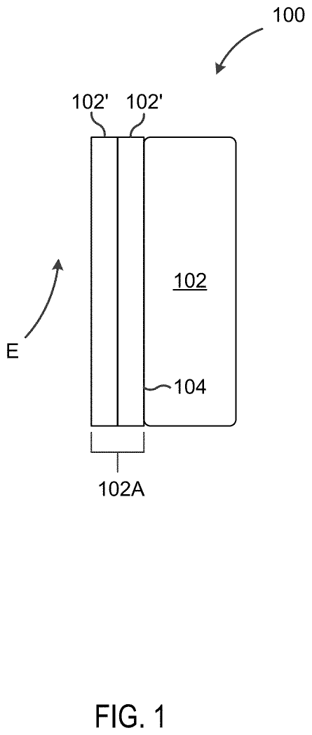

### DETAILED DESCRIPTION

Some embodiments of the systems and methods of the present disclosure are directed to a cathode 100 for use in an energy storage device, e.g., in a lithium-ion battery. In some embodiments, the cathode includes a substrate 102 and a coating 102A disposed on the substrate. In some embodiments, substrate 102 and coating 102A include materials exhibiting high capacity and suitability for operation at high voltage, e.g., above about 4 V. In some embodiments, the substrate includes LiCoO₂ (LCO), Li(NiₓCo_{y}Mn_{1-x-y})O₂(NCM), LiNi_{1-x-y}CoₓAl_{y}O₂ (NCA), or combinations thereof.

In some embodiments, coating 102A includes one or more layers 102′. Coating 102A is configured to stabilize an cathode electrolyte interface 104 between substrate 102 and an electrolyte, e.g., electrolyte E. In some embodiments, one or more layers 102′ include a metal oxide. Without wishing to be bound by theory, the metal oxide layer passivates the surface of cathode 100, a surface of substrate 102, creating the 104 that suppresses oxidation of electrolytes, such as the polymer electrolytes discussed below. The result is advantageously stabilized coulombic efficiency and cycling performance of cathode 100. In some embodiments, the metal oxide includes aluminum oxide. In some embodiments, the metal oxide layer has a thickness of about 1 nm to about 3 nm. In some embodiments, the metal oxide layer has a thickness of about 2 nm. In some embodiments, one or more layers 102′, e.g., the metal oxide, is disposed on cathode 100 via an atomic layer deposition process.

In some embodiments, one or more layers 102′ include a ceramic compound. In some embodiments, one or more layers 102′ include a ceramic electrolyte. Without wishing to be bound by theory, the ceramic electrolyte facilitates ion transport within cathode 100 and prevents oxidation of electrolyte, e.g., electrolyte E, as will be discussed in greater detail below. In some embodiments, the ceramic electrolyte includes Li_{1.5}Al_{0.5}Ge_{1.5}(PO₄)₃(LAGP), Li₁₊ₓAlₓTi₂₋ₓ(PO₄)₃ (LATP), or combinations thereof. In some embodiments, cathode 100 has a weight percent of ceramic electrolyte between about 0.5% and about 10%. In some embodiments, cathode 100 has a weight percent of ceramic electrolyte between about 0.5% and about 4.5%. In some embodiments, cathode 100 has a weight percent of ceramic electrolyte between about 1.5% to about 3.5%. In some embodiments, the ceramic electrolyte is incorporated into cathode 100 using a ball milling and sintering process, as will be discussed in greater detail below. In some embodiments, one or more layers 102′ include one or more LiₓPO_{y} layers suitable for use with substrate 102 and a ceramic electrolyte. In some embodiments, one or more layers 102′ include Li₃PO₄, Li₄P₂O₇, etc., or combinations thereof. In some embodiments, one or more layers 102′ include a separate polymeric coating suitable for use with substrate 102 and a ceramic electrolyte.

In some embodiments, one or more layers 102′ include a decomposed salt layer. In some embodiments, the decomposed salt layer is formed in situ over a ceramic electrolyte layer, as will be discussed in greater detail below.

In some embodiments, electrolyte E includes a carbonate. In some embodiments, electrolyte E includes ethylene carbonate, diethyl carbonate, ethyl methyl carbonate, or combinations thereof. In some embodiments, electrolyte E is a polymer electrolyte. In some embodiments, electrolyte E includes poly(ethylene oxide) (PEO), polyethylene glycol (PEG), or combinations thereof. In some embodiments, electrolyte E includes one or more salts. In some embodiments, the one or more salts include lithium bis(trifluoromethanesulfonyl)imide (LiTFSI), lithium bis(oxalato)borate (LiBOB), lithium hexafluorophosphate (LiPF₆), Li₇La₃Zr₂O₁₂ (LLZO), aluminum oxide, or combinations thereof.

Due to the small thickness of coating 102A, the cathode electrolyte interface 104 does not sacrifice energy density significantly while it remarkably enhances cycling performance. By deploying such cathode electrolyte interface strategy, high capacity retentions of 81.9% over 400 cycles and 84.7% over 200 cycles are achieved in LAGP-LCO/PEO/Li cells at 60° C. with charging cut-off of 4.25 V and 4.3 V, respectively. The stability is further validated in harsher conditions, wherein capacity retention of 88.1%/70 cycles when charged to 4.4 V, and 88.5%/150 cycles at RT are observed. This strategy can also be generalized to NCM, and steady cycling of 93.8% over 100 cycles is observed in NCM523/PEO/Li cells.

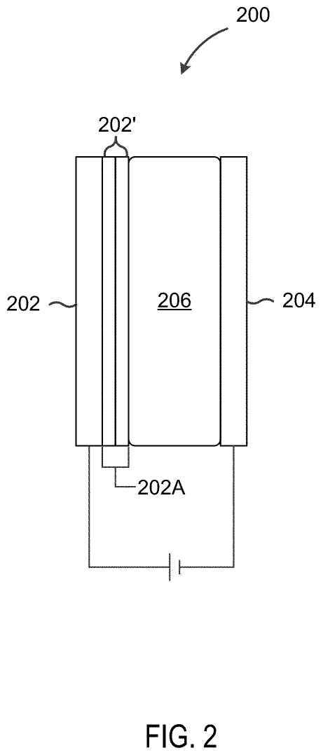

Referring now to FIG. 2, some embodiments of the systems and methods of the present disclosure are directed to incorporating a high voltage cathode, e.g., cathode 100, into an energy storage device 200, e.g., a lithium-ion battery. In some embodiments, energy storage device 200 includes a cathode 202, an anode 204, and an electrolyte 206 interfacing with both the cathode and the anode. As discussed above, in some embodiments, cathode 202 includes a coating 202A including one or more layers 202′ configured to stabilize an interface 206 between cathode 202 and electrolyte 206. In some embodiments, one or more layers 202′ include an oxide or a ceramic compound. In some embodiments, one or more layers 202′ include Li_{1.5}Al_{0.5}Ge_{1.5}(PO₄)₃(LAGP), Li₁₊ₓAlₓTi₂₋ₓ(PO₄)₃ (LATP), aluminum oxide, or combinations thereof.

In some embodiments, anode 204 can be of any material or combination of materials suitable for use with cathode 202 and electrolyte 206. In some embodiments, anode 202 includes lithium metal or graphite. As discussed above, in some embodiments, electrolyte 206 includes a carbonate. In some embodiments, electrolyte 206 includes ethylene carbonate, diethyl carbonate, ethyl methyl carbonate, or combinations thereof. In some embodiments, electrolyte 206 is a polymer electrolyte. In some embodiments, electrolyte 206 includes poly(ethylene oxide) (PEO), polyethylene glycol (PEG), or combinations thereof. Without wishing to be bound by theory, polymer electrolytes such as PEO are much safer than conventional liquid electrolytes due to their high flash point. Difficulties operating these polymer electrolytes at higher voltages have limited their usage in high energy density and power capability applications. However, the coatings according to some embodiments of the present disclosure are able to stabilize the interface of the polymer electrolyte and the cathode, preventing harmful oxidation of the electrolyte and enabling use of the electrolyte in higher voltage applications.

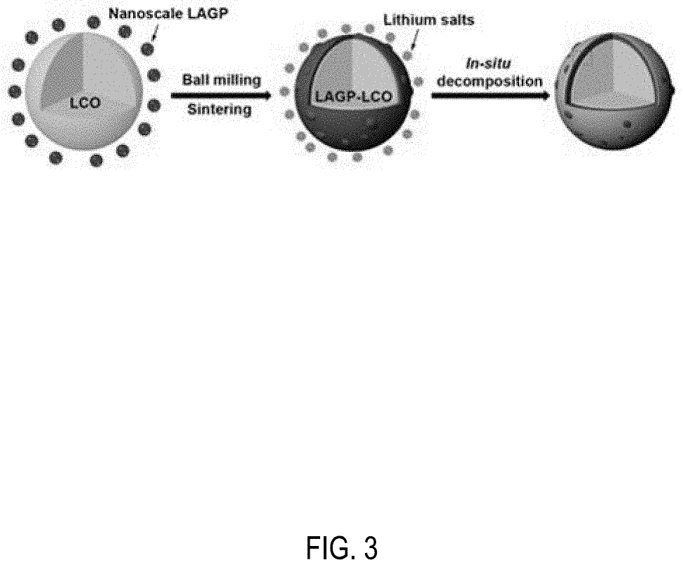

In some embodiments, electrolyte 206 includes one or more salts. In some embodiments, the one or more salts include lithium bis(trifluoromethanesulfonyl)imide (LiTFSI), lithium bis(oxalato)borate (LiBOB), lithium hexafluorophosphate (LiPF₆), Li₇La₃Zr₂O₁₂ (LLZO), aluminum oxide, or combinations thereof. In some embodiments, one or more layers 202′ include a decomposed salt layer. Referring now to FIG. 3, in some embodiments, the decomposed salt layer is formed in situ over cathode 202, e.g., over a ceramic electrolyte layer, from one or more salts included in electrolyte 206. Without wishing to be bound by theory, in some embodiments, a ceramic compound coating such as those discussed above can still have grain boundaries and nanoscale pinholes, which could induce oxidation of electrolyte 206. By carefully configuring the salt content of electrolyte 206, a cathode electrolyte interface is formed on cathode-coating from in-situ decomposition during cycling, thus passivating pinholes in one or more layers 202′, further reducing the oxidation of electrolyte 206.

In some embodiments, energy storage device 200 is configured for stabile operation at or above 4 V. In some embodiments, energy storage device 200 is configured for stabile operation at or above 4.25 V. In some embodiments, energy storage device 200 is configured for stabile operation at or above 4.5 V.

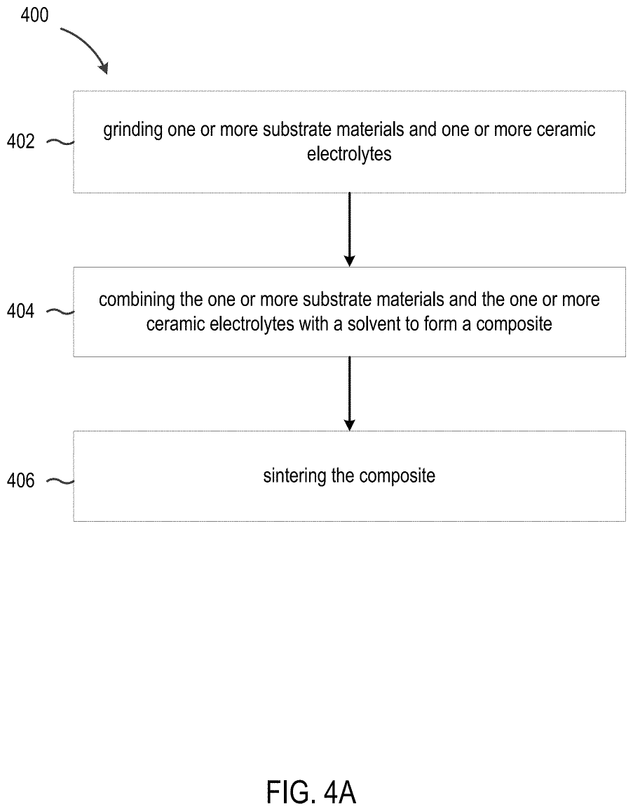

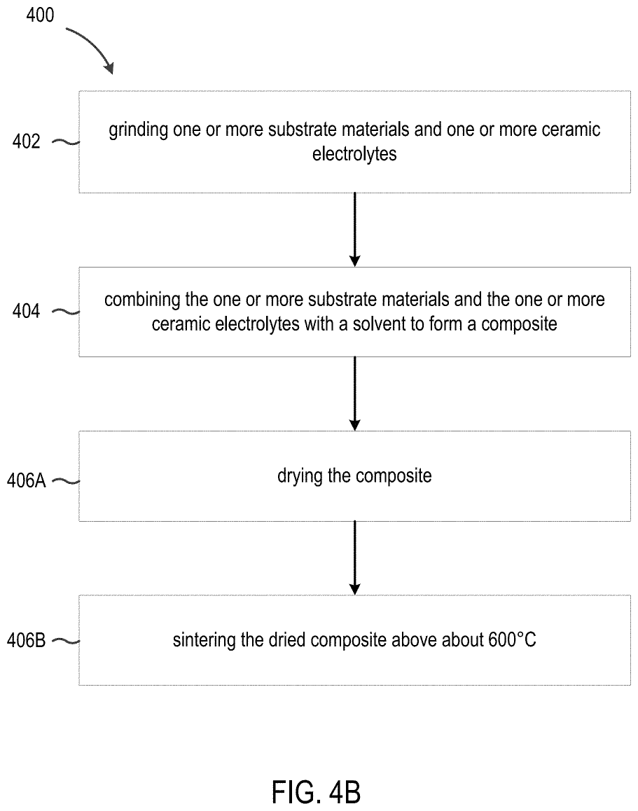

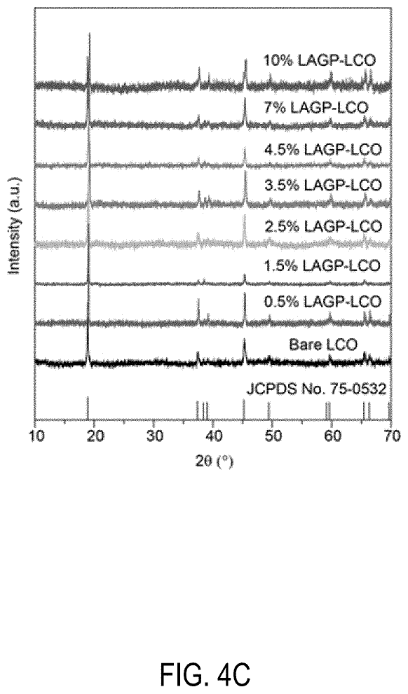

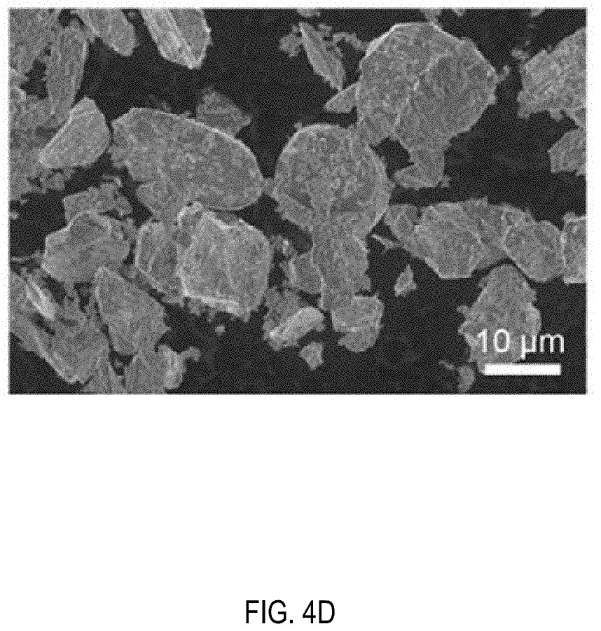

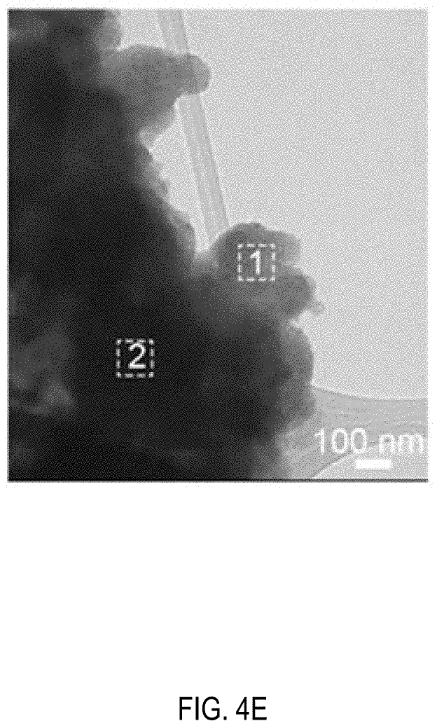

Referring now to FIG. 4A, some embodiments of the systems and methods of the present disclosure are directed to a method of making a cathode for use in an energy storage device, e.g., a lithium-ion battery. In some embodiments, at 402, one or more substrate materials and one or more ceramic electrolytes are ground into particles. In some embodiments, step 402 is a ball milling process. Without wishing to be bound by theory, the ball milling process is effective to both grind the cathode materials, e.g., the substrate and ceramic electrolyte, to a suitable size for casting as a cathode, and also combine and mix the substrate and ceramic electrolyte materials to form the advantageous cathode electrolyte interface discussed above. At 404, the one or more substrate materials and the one or more ceramic electrolytes are combined with a solvent to form a composite. In some embodiments, the solvent includes isopropanol or any other suitable solvent. As discussed above, in some embodiments, the result of method 400 is a composite composed of a plurality of particles having bulk substrate material, e.g., LCO, and a ceramic electrolyte coating, e.g., LAGP. In some embodiments, the average particle size is about 1 μm to about 50 μm. At 406, the composite is sintered to form the cathode. Referring to FIG. 4B, in some embodiments, at 406A, the composite is dried before sintering at 406B. In some embodiments, sintering is performed at a temperature above about 600° C. In some embodiments, sintering is performed at a temperature above about 650° C.

Referring to FIGS. 4C and 4D after the modification, no structural variation between LAGP-modified LCO and pristine LCO (JCPDS No. 75-0532) is observed in X-ray diffraction (XRD) patterns (see FIG. 4C), indicating relatively small amounts of LAGP do not change the structure of LCO. Scanning electron microscopy (SEM) shows the morphology of LCO becomes rough and decorated with LAGP nanoparticles (see FIG. 4D). Referring now to FIG. 4E, transmission electron microscopy (TEM) shows a more detailed morphology, in which LAGP (1) decorates the surface of LCO (2).

### EXAMPLES

Three different kinds of electrolyte combinations were explored, including LiTFSI/LiBOB/LiPF₆ in PEO/PEGDME (electrolyte-1), PEO/PEGDME/EC/PC (electrolyte-2), and PEO/LLZO/PEGDME/EC/PC (electrolyte-3), where LiTFSI, LiBOB, PEGDME, EC, PC, and LLZO are short for lithium bis(trifluoromethanesulfonyl)imide, lithium bis(oxalato)borate, polyethylene glycol dimethyl ether (M_{w}=500), ethylene carbonate, propylene carbonate and Ta-doped Li₇La₃Zr₂O₁₂, respectively. PEO has an M_{w} of 10,000 in all electrolytes. Electrolyte-1 is used as the baseline, while the other two were explored for enhancing conductivity and polymer/ceramic composite electrolyte, respectively. The exact compositions are illustrated in Table 1.

TABLE 1
The ratio of different components of electrolytes. All ratios
are by weight except EC/PC (*EC/PC = 3:7, by volume)

| Electrolytes | Salts | Electrolyte host |
|---|---|---|
| Electrolyte-1 | 0.28M LiTFSI + | PEO:PEGDME = 1:1 |
| | 0.19M LiBOB + | |
| | 0.025M LiPF₆ | |
| Electrolyte-2 | 0.23M LiTFSI + | PEO:PEGDME:EC/PC* = |
| | 0.15M LiBOB + | 3:3:4 |
| | 0.02M LiPF₆ | |
| Electrolyte-3 | 0.33M LiTFSI + | PEO:LLZO:PEGDME:EC/PC* = |
| | 0.22M LiBOB + | 1:2:1:1 |
| | 0.025M LiPF₆ | |

These electrolytes are all solid-state at RT. The electrolytes are also fire-retardant and show excellent thermal stability, as characterized by resistance to ignition. Electrolyte-1, 2 and 3 show ionic conductivities of 7.8×10⁻⁶, 7.7×10⁻⁴ and 2.3×10⁻⁴ S cm⁻¹ at RT, which further increase to 7.0×10⁻⁴, 2.2×10⁻³ and 1.1×10⁻³ S cm⁻¹ at 60° C., respectively. These values are 1-3 orders of magnitude higher than pure PEO electrolytes due to the addition of liquid plasticizer and ceramic electrolytes. The electrolytes also show steady cycling in Li/Li symmetric cells. At 0.3 mA cm⁻² and 0.3 mAh cm⁻², the overpotential of Li/Li cells only increases from 80 to 120 mV over 2000 hours with electrolyte-1. The surface of Li metal remains dense after cycling, suggesting good interfacial stability between the electrolyte and Li metal.

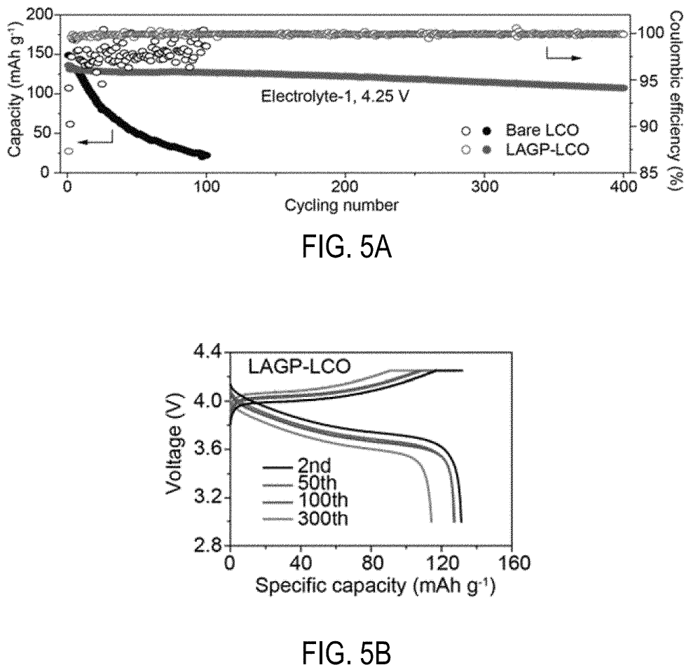

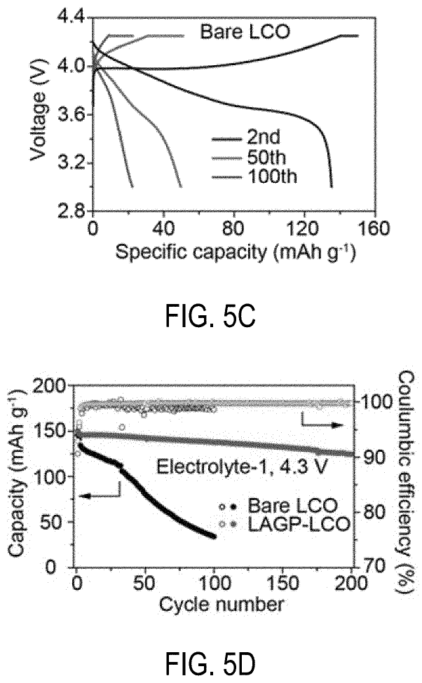

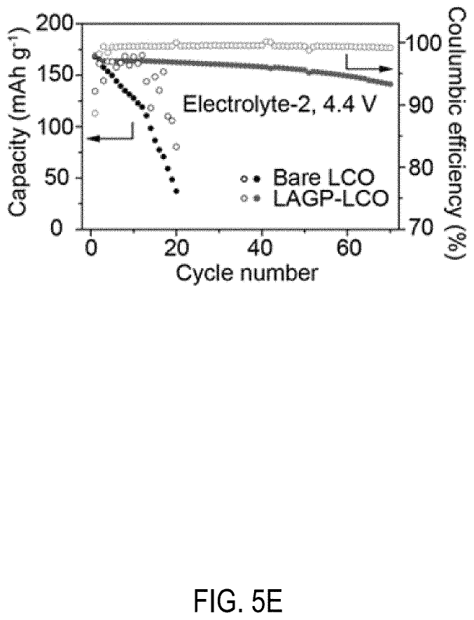

Given the good stability between the multi-component PEO-based electrolytes and lithium anode, LAGP-LCO/Li cells were further tested in the range of 3-4.25/4.3/4.4 V at 60° C. The current rate was 0.3 C for charging with a constant voltage step down to 0.05 C and 0.5 C for discharge (1 C=145 mA g⁻¹), after one formation cycle at 0.1 C. The LAGP-LCO/Li cell with electrolyte-1 showed excellent cycling performance with an initial specific capacity of 131.2 mAh g⁻¹ and 107.4 mAh g⁻¹ after 400 cycles, which represents capacity retention of 81.9% (see FIGS. 5A and 5B), or only 0.05% decay per cycle. Moreover, the CE was 87.3% for the first cycle and then reached averagely 99.9% for the following cycles, indicating nearly no side reaction due to PEO oxidation. In contrast, the bare LCO/Li cell showed a steady capacity drop from 135.1 mAh g⁻¹ to only 22.2 mAh g⁻¹ after 100 cycles (see FIGS. 5A and 5C). Its CE also fluctuated between 95% and 99% and averaged at 97.8% for the first 100 cycles. When cycled with electrolyte-2, similar performance was observed. These results demonstrate that the LAGP nano-coating highly beneficial for suppressing side reactions and stabilizing the LCO/electrolyte interface.

Significantly enhanced stability was also observed when the cut-off voltage increased to 4.3 V and 4.4 V. At 4.3 V, LAGP-LCO/Li cell showed an initial specific capacity of 150.4 mAh g⁻¹ at 0.1 C and 147.0 mAh g⁻¹ at 0.5 C with electrolyte-1, and slightly decreased to 132.4 mAh g⁻¹ over 200 cycles with a capacity retention of 84.7% (see FIG. 5D). In contrast, bare LCO/Li cell showed rapid decay from 141.4 to 33.8 mAh g⁻¹ after 100 cycles. The CE for LAGP-LCO/Li cell was ˜99.7% in most cycles, while for bare LCO, CE decreased below 98.8% after 30 cycles, indicating strong side reactions.

When further charged to 4.4 V utilizing electrolyte-2, the initial specific capacity reached 169.2 mAh g⁻¹ at 0.1 C and 163.7 mAh g⁻¹ at 0.5 C for LAGP-LCO, which dropped to 162.5 mAh g⁻¹ after 20 cycles, and 141.2 mAh g⁻¹ after 70 cycles, representing a capacity retention of 86.3% (see FIG. 5E). The corresponding average CE was 99.4%. The overpotential slightly increased from 0.05 V to 0.1 V after 20 cycles and 0.2 V after 70 cycles. In contrast, the specific capacity of bare LCO decreased from 165.0 to 37.2 mAh g⁻¹ after only 20 cycles and the overpotential increased from 0.04 to 0.7 V (see FIG. 5E). The average CE was only 94.1%. The improved cycling performance was also confirmed by cyclic voltammetry. These data at 4.3 and 4.4 V demonstrate the effectiveness of the nanoscale coating for stabilizing the LCO/PEO interface.

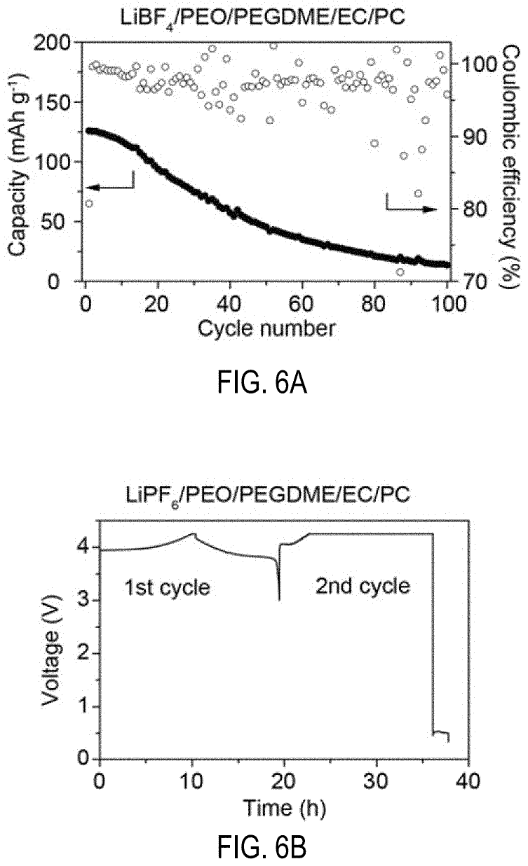

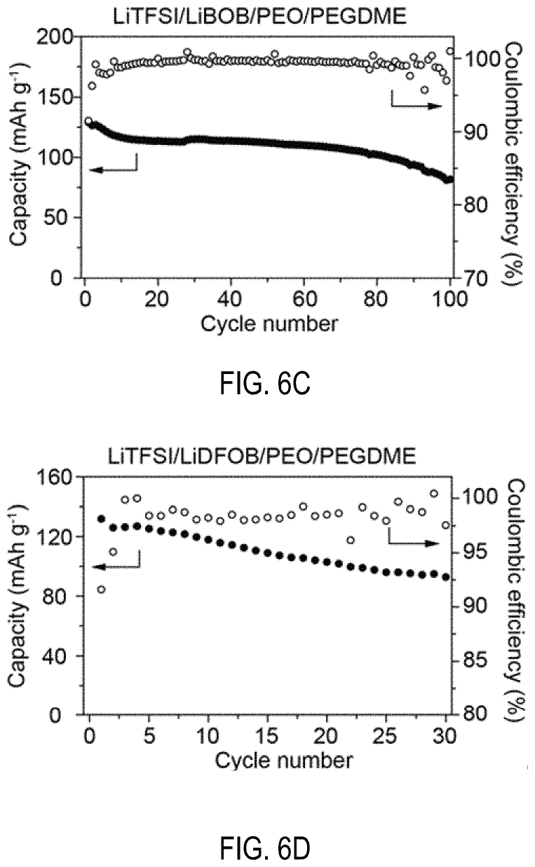

Salt composition of electrolyte was also tested. When LAGP-LCO/Li cell was combined with LiBF₄/PEO, the capacity decayed (10.8% retention/100 cycles) with an average CE of 96.9% (see FIG. 6A). Charging the LAGP-LCO/Li cell utilizing LiPF₆/PEO-based electrolyte was limited after two cycles (see FIG. 6B). Moreover, the LAGP-LCO/Li cell with electrolyte-1 but no LiPF₆ additive showed a noticeably faster drop of capacity (see FIG. 6C), which may be due to the corrosion of aluminum current collector and worse cycling of lithium anode. Replacing LiPF₆ with LiBF₄ also led to worse performance. Additionally, concentrated 1 M LiTFSI+1 M lithium difluoro (oxalate) borate (LiDFOB) in PEO/PEGDME also failed to enable as stable cycling in LCO/Li cell (see FIG. 6D) as its 1,2-dimethoxyethane counterpart. These results suggest that the nanoscale cathode electrolyte interface from salt decomposition prevent PEO oxidation and enable stable cycling. Hence, the results prove the importance of LAGP nano-coating, as well as the combination of LiTFSI/LiBOB/LiPF₆ salts, which synergize to produce improved stable cycling in PEO-based electrolyte with LCO cathode.

In order to comprehensively evaluate the performance of 4 V PEO solid batteries with such a coating strategy, their performance was tested at various conditions, such as cycling at RT, using thin Li anode (40 μm), replacing LCO with NCM523, and the addition of LLZO ceramic particles. Steady cycling has been observed in all cases, as discussed below.

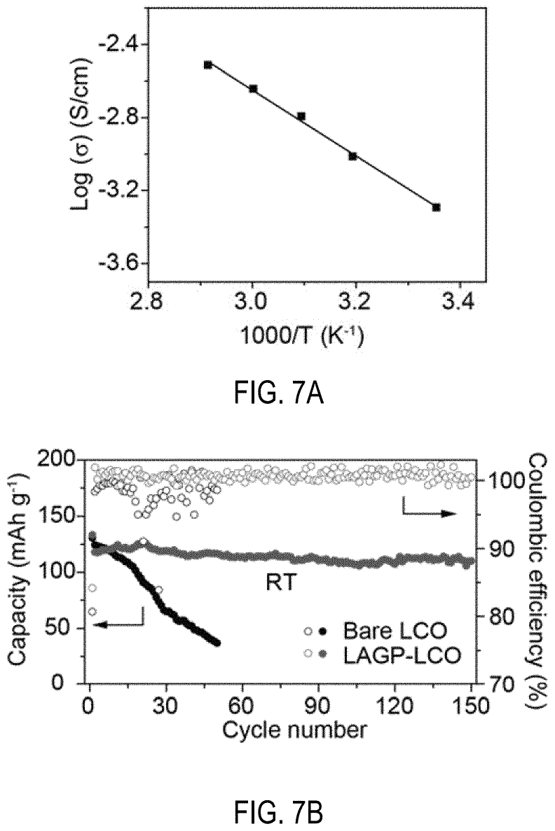

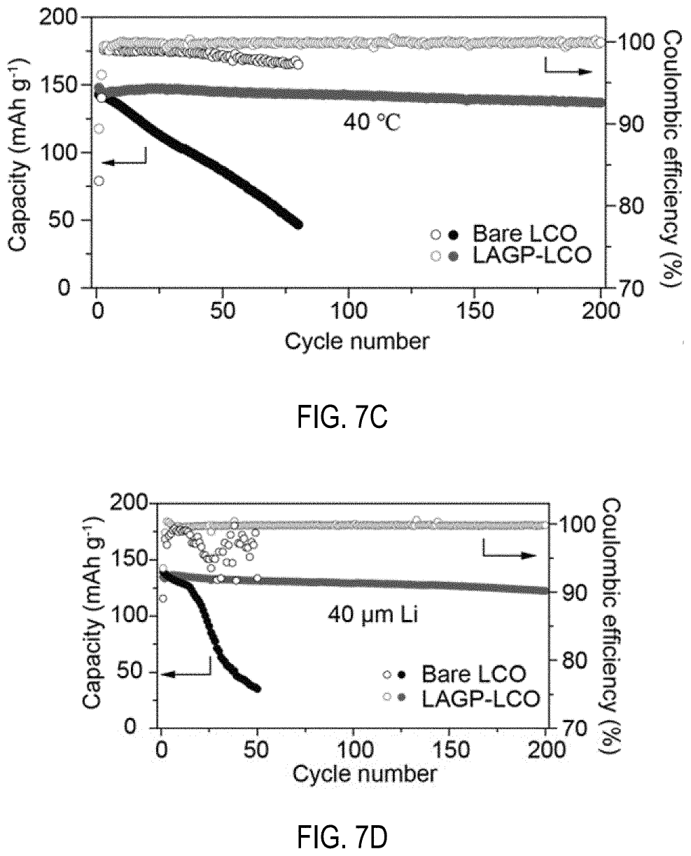

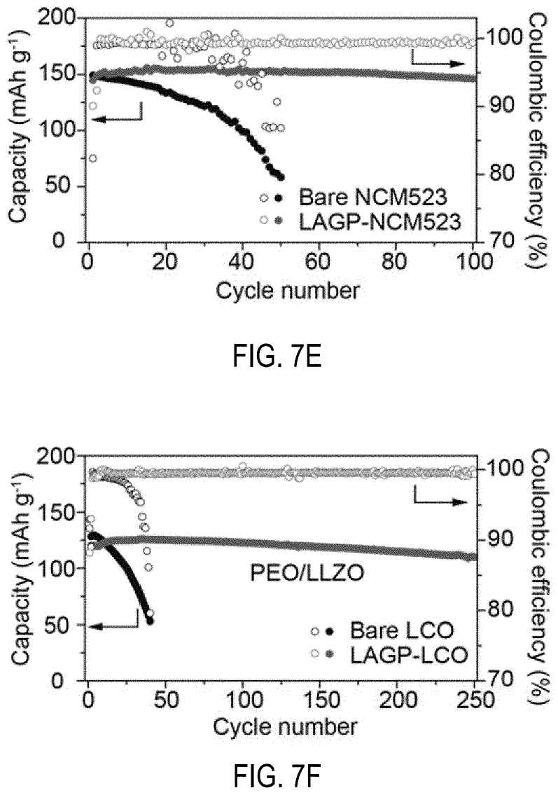

First, although 60° C. can be an acceptable temperature for electric vehicles, it is beneficial to have battery functional at RT. By addition of 25 wt. % EC/PC plasticizer inside, the ionic conductivity of PEO electrolyte reached 5.1×10⁻⁴ S cm⁻¹ at RT (see FIG. 7A). Consequently, capacity retention of 88.5% over 150 cycles was achieved at 0.2 C at RT (see FIG. 7B). Similarly, retention of 93.0%/200 cycles was observed at 40° C. (see FIG. 7C). Upon further increasing the ratio of EC/PC to 50 wt. %, the cells discharged at 1 C. Besides RT operation, cells with 40 μm-thin lithium instead of conventional 250 μm-thick lithium were tested in a LAGP-LCO/PEO/Li cell. Capacity retention of 89.7% was reached after 200 cycles at 60° C. (see FIG. 7D). Although the cathode loading was only 1 mAh cm⁻², this still indicates that the CE is at least 96%, much higher than 90% in conventional carbonate electrolyte. These results support that PEO is an attractive electrolyte for solid-state lithium metal batteries.

While LCO is a model 4 V cathode, NCM is the standard material in electric vehicles. Thus, the coatings according to some embodiments of the present disclosure were further tested in NCM523. As shown in FIG. 7E, LAGP-coated NCM523 showed a capacity retention of 93.8%/100 cycles between 3 and 4.3 V at 60° C., much better than bare NCM523 (39.2%/50 cycles). On the other side, such coatings can also be extended to polymer/ceramic composite electrolytes. In electrolyte-3 with 60 wt. % solid content (PEO/LLZO) or 80 wt. % for PEO/PEGDME/LLZO, steady performance of 87.2% over 250 cycles is observed for 3-4.25 V at 60° C. (see FIG. 7F). When LLZO is replaced by Al₂O₃ nanoparticles, stable cycling performance is also achieved. These cycling data are summarized as Table 2 below:

TABLE 2
Summary of capacity retention and CE in LCO/Li
and LAGP-LCO/Li cells at different conditions.

| Testing condition | | |
|---|---|---|
| Electrolyte-1, 4.25 V | Electrolyte-1, 4.3 V | Electrolyte-2, 4.4 V |

| | LAGP- | | LAGP- | | LAGP- | Bare |
|---|---|---|---|---|---|---|
| Cathode | LCO | Bare LCO | LCO | Bare LCO | LCO | LCO |
| Capacity retention | 81.9%/400 | 16.4%/100 | 84.7%/200 | 23.9%/100 | 86.3%/70 | 22.5%/20 |
| (/cycle number) | | | | | | |
| Average CE | 99.9% | 97.8% | 99.7% | 98.8% | 99.4% | 94.0% |

| | Testing condition | | | | | |
|---|---|---|---|---|---|---|
| | Room Temperature | | Electrolyte-1, 40 μm Li | | NCM523 | |
| | LAGP- | | LAGP- | | LAGP- | Bare |
| Cathode | LCO | Bare LCO | LCO | Bare LCO | NCM | NCM |
| Capacity retention | 88.5%/150 | 29.7%/50 | 89.7%/200 | 25.5%/50 | 93.8%/100 | 39.2%/50 |
| (/cycle number) | | | | | | |
| Average CE | 99.9% | 97.6% | 99.7% | 96.6% | 99.3% | 96.6% |

Prepared LAGP-LCO cathodes were also tested in LAGP-LCO/Li half cells with most common used commercial liquid electrolytes, including electrolyte-4 (1 M LiPF₆ in EC/DEC (EC:DEC=1:1, w/w)) and electrolyte-5 (1.2 M LiPF₆ in EC/EMC (EC:EMC=3:7, v/v)), as well as home-made electrolyte-6 (0.6 M LiTFSI+0.4 M LiBOB+0.05 M LiPF₆ in EC/PC (EC:PC=3:7, v/v)). The cut-off voltage was set at 3-4.5 V and the cells were charged at 0.3 C, followed by constant voltage charge process until the current density reduced to 0.05 C, then discharged at 1 C (1 C=1.37 mA cm⁻²).

Different weight ratios of LAGP from 10% to 0.5% were investigated. When the ratio of LAGP utilized decreased from 10 wt. % to 1.5 wt. %, the initial specific capacity increases, while the initial specific capacity decreased with the further decrease of LAGP content. Using electrolyte-4 as an example, the specific capacity increased from 163.1 mAh to 194.4 mAh g⁻¹, followed by dropping to 183.9 mAh g⁻¹ at 0.1 C when the dosage of LAGP decreased from 10 wt. % to 1.5 wt. %, and further to 0. The initial specific capacity and capacity retention are summarized in Table 3:

TABLE 3
Summary of initial specific capacity at 0.1 C and capacity retention
of LAGP-LCO/Li cells with different ratios of LAGP.

| | | Initial specific | Capacity |
|---|---|---|---|
| | LAGP ratio | capacity (mAh g⁻¹) | retention (%) |
| Electrolyte-4 | 10% | 163.1 | 92.7%/300 cycles |
| | 7% | 173.0 | 89.9%/200 cycles |
| | 4.5% | 182.1 | 82.0%/300 cycles |
| | 3.5% | 183.4 | 88.0%/400 cycles |
| | 2.5% | 186.3 | 80.9%/300 cycles |
| | 1.5% | 194.4 | 93.1%/250 cycles |
| | 0.5% | 185.8 | 25.8%/150 cycles |
| | 0 | 183.9 | 7.3%/150 cycles |
| Electrolyte-5 | 4.5% | 182.0 | 68.7%/200 cycles |
| | 3.5% | 185.1 | 80.5%/350 cycles |
| | 2.5% | 189.7 | 41.1%/300 cycles |
| | 1.5% | 190.5 | 67.2%/300 cycles |
| | 0.5% | 190.1 | 12.3%/150 cycles |
| | 0 | 188.8 | 1.5%/100 cycles |
| Elctrolyte-6 | 7% | 170.5 | 81.6%/800 cycles |
| | 4.5% | 177.5 | 91.8%/700 cycles |
| | 3.5% | 180.2 | 82.1%/1000 cycles |
| | 2.5% | 183.4 | 88.6%/500 cycles |
| | 1.5% | 186.3 | 48.7%/600 cycles |
| | 0 | 184.7 | 0.3%/100 cycles |

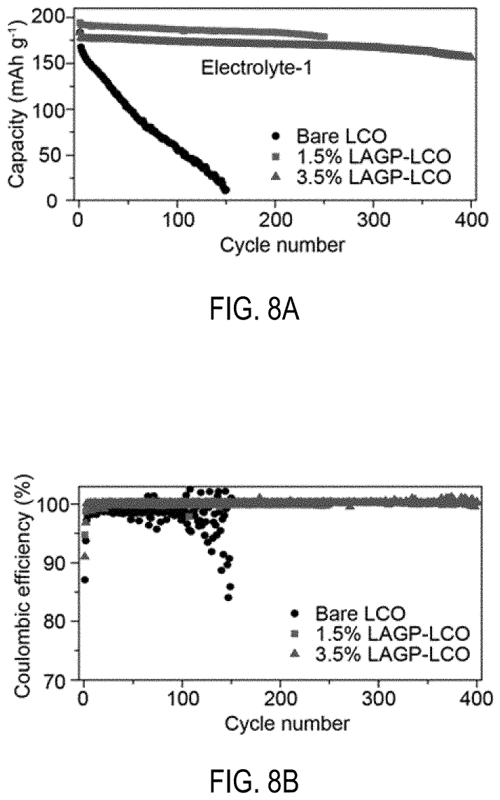

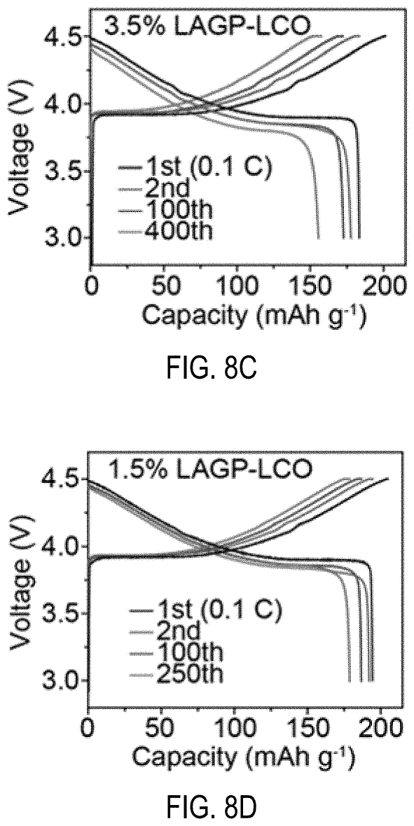

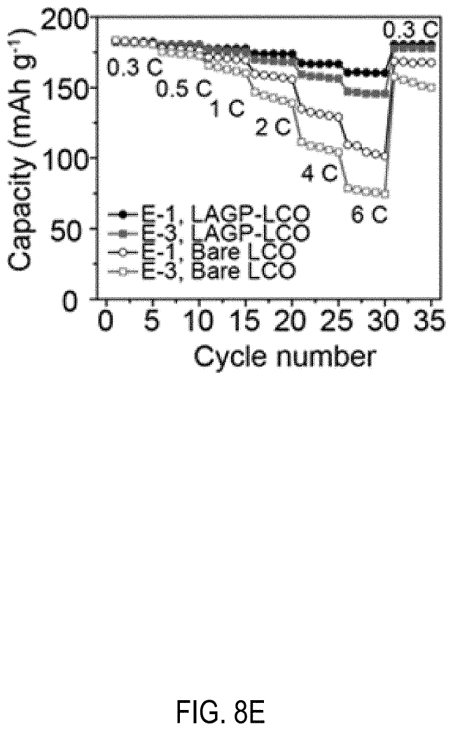

With electrolyte-4, 3.5% LAGP-LCO/Li cell delivered an initial specific capacity of 183.4 mAh g⁻¹ at 0.1 C and 177.7 mAh g⁻¹ at 1 C, then the specific capacity slightly dropped to 156.4 mAh g⁻¹ after 400 cycles with capacity retention of 88.0% (see FIG. 8A). In contrast, bare LCO/Li cell showed a little bit higher initial specific capacity (183.9 mAh g⁻¹), but fast fading at 1 C from 167.6 mAh g⁻¹ to 12.3 mAh g⁻¹ after 150 cycles with a poor retention of 7.3% (see FIGS. 8A and 8C). Moreover, 3.5% LAGP enabled superior initial CE and average CE compared with bare LCO, featuring 91.0% and 99.9% for LAGP-LCO versus 87.1% and 98.1% for bare LCO. These indicate the notable side reactions in bare LCO were suppressed with LAGP. Regarding overpotential, the LAGP-LCO/Li cell was much more stable than the bare LCO counterpart. It only grew from 0.05 V at the 2^{nd} cycle to 0.08 V at the 400^{th} cycle in LAGP-LCO/Li cell (see FIG. 8B), while it increased quickly from 0.04 at the 2^{nd} cycle V to 1 V at the 150^{th} cycle in bare LCO/Li cell (see FIG. 8C). Additionally, fast charge/discharge can be realized with charge/discharge current rates of 2C/2C.

Another commercial electrolyte, 1.2 M LiPF₆ in EC/EMC (electrolyte-5), was utilized to demonstrate the significant improvement in electrochemical performance with the LAGP modification. Impressively, stable cycling with ultra-high capacity retention of 95.8%/200 cycles was observed. In these results, 1.5 wt. % LAGP endowed the highest initial specific capacity, 194.4 mAh g⁻¹ at 0.1 C and 192.1 mAh g⁻¹ at 1 C, respectively (see FIG. 8D). This method is more effective especially when home-made electrolyte-6 is used. The LAGP-modification endowed an ultra-stable cycling over 1000 cycles with capacity retention of 82.1% (see FIG. 8E). Without wishing to be bound by theory, the capacity decay in LAGP-LCO/Li cell is not ascribed to failure of LCO itself, but to the lithium anode and electrolyte.

Besides the cycling stability, 3.5% LAGP-LCO also provided better power capability, featuring reversible specific capacity of 183.0, 180.3, 177.6, 174.0, 166.8, 160.9 mAh g⁻¹ at 0.3 C, 0.5 C, 1 C, 2 C, 4 C, and 6 C with electrolyte-4 in 3-4.5 V, respectively. In contrast, bare LCO cell showed specific capacity of 182.6, 177.8, 171.2, 158.8, 132.6, 108.7 mAh g⁻¹ at 0.3 C, 0.5 C, 1 C, 2 C, 4 C, and 6 C, respectively. The reversible specific capacity of bare LCO was much lower than that of LAGP-LCO at high rates, which can be also observed with electrolyte-6. These results indicate the electrochemical performance is significantly improved with LAGP ceramic electrolyte.

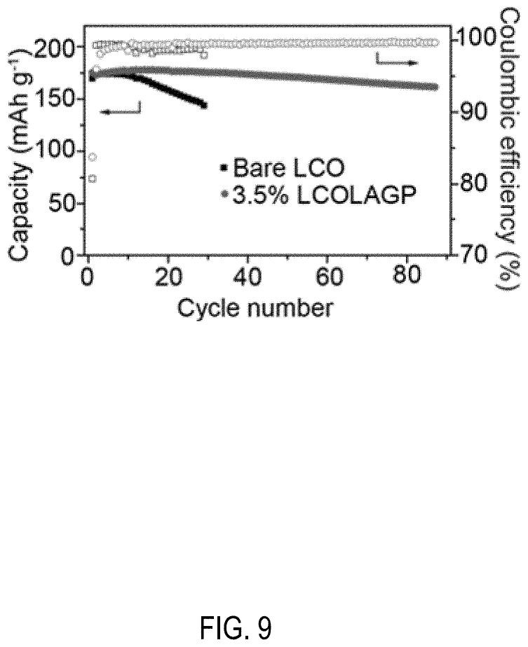

Referring now to FIG. 9, bare LCO/graphite and 3.5% LAGP-LCO/graphite full cells with negative/positive (N/P) ratio of 1:1.1˜1.2 were assembled and cycled in the voltage range of 2.5-4.45 V (vs. graphite). The graphite anode and liquid electrolyte used are commercial natural graphite (NG) and 1.2 M LiPF6 in EC/EMC (EC:EMC=3:7, v/v) with 1.5 wt. % VC addictive, respectively. As shown in FIG. 9, the initial specific capacity was 175.5 mAh g⁻¹, which is similar to that of bare LCO/NG cell (169.8 mAh g⁻¹). After 87 cycles at 0.3 C, LAGP-LCO/NG cell showed capacity retention as 90.1%, while that of bare LCO/NG is 82.4% after only 29 cycles.

Methods and systems of the present disclosure are advantageous in that they significantly enhance the interfacial stability between cathode and electrolyte in energy storage devices without sacrificing energy density noticeably. The LAGP-LCO cathodes provide good power capability at 60° C., featuring reversible specific capacity of 140.6, 138.5, 134.6, and 118.3 mAh g⁻¹ at 0.1 C, 0.3 C, and 0.5 C, and 1 C in 3-4.25 V, respectively. In contrast, bare LCO cells show specific capacity of 143.1, 136.7, 128.4, and 95.7 mAh g⁻¹ at 0.1 C, 0.3 C, 0.5 C, and 1 C, respectively, lower than that of LAGP-LCO at high rates. Finally, the batteries according to some embodiments of the present disclosure allow for practical use of PEO-based electrolytes, which do not catch fire when ignited. The batteries of the present disclosure also exhibit improved stability between PEO electrolytes and high voltage cathodes, opening up new possibilities for practical application of solid-state lithium metal batteries with high energy density.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A cathode for use in a lithium-ion battery, the cathode comprising:
a substrate; and
a coating disposed on the substrate including one or more layers, the coating configured to stabilize an interface between the substrate and a polymer electrolyte.

2. The cathode according to claim 1, wherein the substrate includes LiCoO₂ (LCO), Li(NiCo_{y}Mn_{1-x-y})O₂(NCM), LiNi_{1-x-y}CoₓAl_{y}O₂ (NCA), or combinations thereof.

3. The cathode according to claim 2, wherein the one or more layers includes a metal oxide.

4. The cathode according to claim 3, wherein the metal oxide is aluminum oxide.

5. The cathode according to claim 3, wherein the metal oxide layer has thickness between about 1 nm and about 3 nm.

6. The cathode according to claim 2, wherein the one or more layers includes a ceramic electrolyte.

7. The cathode according to claim 6, wherein the ceramic electrolyte includes Li_{1.5}Al_{0.5}Ge_{1.5}(PO₄)₃(LAGP), Li₁₊ₓAlₓTi₂₋ₓ(PO₄)₃ (LATP), or combinations thereof.

8. The cathode according to claim 7, wherein the cathode has a weight percent of ceramic electrolyte between about 0.5% and about 10%.

9. The cathode according to claim 8, wherein the cathode has a weight percent of ceramic electrolyte between about 1.5% to about 3.5%.

10. The cathode according to claim 2, wherein the one or more layers includes a decomposed salt layer.

11. A method of making a cathode for use in a lithium-ion battery, the method comprising:
grinding one or more substrate materials and one or more ceramic electrolytes;
combining the one or more substrate materials and the one or more ceramic electrolytes with a solvent to form a composite; and
sintering the composite.

12. The method according to claim 11, wherein grinding the one or more substrate materials and ceramic electrolytes includes a ball milling process.

13. The method according to claim 11, wherein the one or more substrate materials include LiCoO₂ (LCO), Li(NiCo_{y}Mn_{1-x-y})O₂(NCM), LiNi_{1-x-y}CoₓAl_{y}O₂ (NCA), or combinations thereof.

14. The method according to claim 11, wherein the one or more ceramic electrolytes include Li_{1.5}Al_{0.5}Ge_{1.5}(PO₄)₃(LAGP), Li₁₊ₓAlₓTi₂₋ₓ(PO₄)₃ (LATP), or combinations thereof.

15. The method according to claim 11, further comprising forming in situ a decomposed salt layer over the composite.

16. The method according to claim 11, wherein sintering the composite includes:
drying the composite; and
sintering the dried composite above about 600° C.

17. A lithium-ion battery, comprising:
a cathode including a substrate and a coating disposed on the substrate;
an anode; and
an electrolyte interfacing with both the cathode and the anode,
wherein the coating includes one or more layers and is configured to stabilize an interface between the cathode and the electrolyte, wherein the one or more layers includes an oxide or a ceramic compound;
wherein the battery is configured for stabile operation at or above 4 V.

18. The battery according to claim 17, wherein the electrolyte includes poly(ethylene oxide) (PEO), polyethylene glycol (PEG), a carbonate, or combinations thereof, and one or more salts including lithium bis(trifluoromethanesulfonyl)imide (LiTFSI), lithium bis(oxalato)borate (LiBOB), lithium hexafluorophosphate (LiPF₆), Li₇La₃Zr₂O₁₂ (LLZO), aluminum oxide, or combinations thereof.

19. The cathode according to claim 17, wherein the substrate includes LiCoO₂ (LCO), Li(NiₓCo_{y}Mn_{1-x-y})O₂(NCM), LiNi_{1-x-y}CoₓAl_{y}O₂ (NCA), or combinations thereof, and the coating includes Li_{1.5}Al_{0.5}Ge₁ₛ(PO₄)₃(LAGP), Li₁₊ₓAlₓTi₂₋ₓ(PO₄)₃ (LATP), aluminum oxide, or combinations thereof.

20. The cathode according to claim 17, wherein the anode includes lithium metal or graphite.
